(19) United States
(12) Patent Application Publication
(10) Pub. No.: US 2006/0122312 A1
(43) Pub. Date: Jun. 8, 2006

(54) Nanocomposite composition having high barrier property

(76) Inventors: Myung Ho Kim, Daejeon-city (KR); Minki Kim, Daejeon-city (KR); Sehyun Kim, Daejeon-city (KR); Youngtock Oh, Daejeon-city (KR); Jaeyong Shin, Daejeon-city (KR); Youngchul Yang, Daejeon-city (KR)

Correspondence Address: CANTOR COLBURN, LLP, 55 GRIFFIN ROAD SOUTH, BLOOMFIELD, CT, 06002, US

(21) Appl. No.: 11/254,630

(22) Filed: Oct. 20, 2005

(30) Foreign Application Priority Data
Dec. 7, 2004 (KR) 10-2004-0102213
Jun. 2, 2005 (KR) 10-2005-0047115

(51) Int. Cl. C08K 9/04

(52) U.S. Cl. 524/445

(57) ABSTRACT

A nanocomposite composition having a high barrier property and an article manufactured therefrom are provided. A compatibilizer/intercalated clay nanocomposite and a resin having a barrier property/intercalated clay nanocomposite are dispersed as a specific structure in a polyolefin resin. Accordingly, the compositon has superior mechanical strength, and superior oxygen, organic solvent, and moisture barrier properties.

### CROSS-REFERENCE TO RELATED PATENT APPLICATION

This application claims the benefit of Korean Patent Application No. 10-2004-0102213, filed on Dec. 7, 2004, and Korean Patent Application No. 10-2005-0047115, filed on Jun. 2, 2005, in the Korean Intellectual Property Office, the disclosures of which are incorporated herein in their entirety by reference.

### BACKGROUND OF THE INVENTION

1. Field of the Invention

The present invention relates to a dry-blended nanocomposite composition including a polyolefin resin, a nanocomposite of a compatibilizer and an intercalated clay, and a nanocomposite of an intercalated clay and a resin having a barrier property, and an article manufactured therefrom.

2. Description of the Related Art

General-purpose resins, such as polyethylene and polypropylene, are used in many fields due to their superior moldability, mechanical properties, and moisture barrier properties. However, they are limited in their use in packaging or containers for agrochemicals and foods, which require superior chemical and oxygen barrier properties. Therefore, packaging or containers for such materials are manufactured with multi-layers by co-extrusion, lamination, coating, etc.

An ethylene-vinyl alcohol (EVOH) copolymer and polyamide are used in multi-layer plastic products due to their high transparency and superior gas barrier properties. Because these resins are more expensive than general-purpose resins, there has been demand for a resin composition capable of obtaining superior barrier properties even when small amounts of these resins are used.

Meanwhile, when a nano-sized intercalated clay is mixed with a polymer matrix to form a fully exfoliated, partially exfoliated, intercalated or partially intercalated nanocomposite, it has an improved barrier property due to its morphology. Thus, an article having a barrier property manufactured using such a nanocomposite is emerging.

It is important for the nanocomposite to maintain its fully exfoliated, partially exfoliated, intercalated, or partially intercalated morphology even after being molded and fully exfoliated morphology is advantageous in the improvement of barrier properties. In particular, when a molded article is prepared from a composition of the nanocomposite and a matrix polymer, the morphology of the nanocomposite dispersed in the matrix polymer is also important to improve barrier properties.

### SUMMARY OF THE INVENTION

The present invention provides a nanocomposite composition having superior mechanical strength and superior oxygen, organic solvent, and moisture barrier properties, in which a nanocomposite having a barrier property can maintain its exfoliated morphology and is dispersed as a specific structure in a matrix polymer even after being molded.

The present invention also provides an article manufactured from the nanocomposite composition.

According to an aspect of the present invention, there is provided a dry-blended nanocomposite composition including: 40 to 96 parts by weight of a polyolefin resin; 1 to 30 parts by weight of a compatibilizer/intercalated clay nanocomposite; and 0.5 to 60 parts by weight of a nanocomposite having a barrier property, including an intercalated clay and at least one resin having a barrier property, selected from the group consisting of an ethylene-vinyl alcohol copolymer, a polyamide, an ionomer and a polyvinyl alcohol.

According to another aspect of the present invention, there is provided an article manufactured from the nanocomposite composition.

In an embodiment of the present invention, the article may be a container, a sheet, or a film.

In another embodiment of the present invention, the polyolefin resin may be at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

In another embodiment of the present invention, the intercalated clay may include at least one material selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

In another embodiment of the present invention, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

In another embodiment of the present invention, the ionomer may have a melt index of 0.1 to 10 g/10 min (190° C., 2,160 g).

In another embodiment of the present invention, the compatibilizer may be at least one compound selected from an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer.

### DETAILED DESCRIPTION OF THE INVENTION

The present invention will now be explained in more detail.

A dry-blended nanocomposite composition having a barrier property according to an embodiment of the present invention include: 40 to 96 parts by weight of a polyolefin resin; 1 to 30 parts by weight of a compatibilizer/intercalated clay nanocomposite; and 0.5 to 60 parts by weight of a nanocomposite having a barrier property, including an intercalated clay and at least one resin having a barrier property, selected from the group consisting of an ethylene-vinyl alcohol copolymer, a polyamide, an ionomer and a polyvinyl alcohol.

The polyolefin resin may be at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

The content of the polyolefin resin is preferably 40 to 96 parts by weight, and more preferably 70 to 85 parts by weight. If the content of the polyolefin resin is less than 40 parts by weight, molding is difficult. If the content of the polyolefin resin is greater than 96 parts by weight, the barrier property is poor.

The nanocomposite having a barrier property can be prepared by blending an intercalated clay and at least one resin having a barrier property selected from the group consisting of an EVOH copolymer, a polyamide, an ionomer and a polyvinyl alcohol (PVA). The prepared nanocomposite has a fully exfoliated, partially exfoliated, intercalated, or partially intercalated morphology.

The intercalated clay is preferably an organic intercalated clay. The content of an organic material in the intercalated clay is preferably 1 to 45 wt %. When the content of the organic material is less than 1 wt %, the compatibility of the intercalated clay and the resin having a barrier property is poor. When the content of the organic material is greater than 45 wt %, the intercalation of the resin having a barrier property is difficult.

The organic material has at least one functional group selected from the group consisting of from primary ammonium to quaternary ammonium, phosphonium, maleate, succinate, acrylate, benzylic hydrogen, oxazoline, and dimethyldistearylammonium.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from primary ammonium to quaternary ammonium, phosphonium, maleate, succinate, acrylate, benzylic hydrogen, oxazoline and dimethyldistearylammonium.

If an ethylene-vinyl alcohol copolymer is included in the nanocomposite, the content of ethylene in the ethylene-vinyl alcohol copolymer is preferably 10 to 50 mol %. If the content of ethylene is less than 10 mol %, melt molding becomes difficult due to poor processability. If the content of ethylene exceeds 50 mol %, oxygen and liquid barrier properties are insufficient.

If polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

The amorphous polyamide refers to a polyamide having insufficient crystallinity, that is, not having an endothermic crystalline melting peak when measured by a differential scanning calorimetry (DSC) (ASTM D-3417, 10° C./min).

In general, the polyamide can be prepared using diamine and dicarboxylic acid. Examples of the diamine include hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidene, 1,4-diaminocyclohexane, 1,3-diaminocyclohexane, meta-xylenediamine, 1,5-diaminopentane, 1,4-diaminobutane, 1,3-diaminopropane, 2-ethyldiaminobutane, 1,4-diaminomethylcyclohexane, methane-xylenediamine, alkyl-substituted or unsubstituted m-phenylenediamine and p-phenylenediamine, etc. Examples of the dicarboxylic acid include alkyl-substituted or unsubstituted isophthalic acid, terephthalic acid, adipic acid, sebacic acid, butanedicarboxylic acid, etc.

Polyamide prepared using aliphatic diamine and aliphatic dicarboxylic acid is general semicrystalline polyamide (also referred to as crystalline nylon) and is not amorphous polyamide. Polyamide prepared using aromatic diamine and aromatic dicarboxylic acid is not easily treated using a general melting process.

Thus, amorphous polyamide is preferably prepared, when one of diamine and dicarboxylic acid used is aromatic and the other is aliphatic. Aliphatic groups of the amorphous polyamide are preferably C₁-C₁₅ aliphatic or C₄-C₈ alicyclic alkyls. Aromatic groups of the amorphous polyamide are preferably substituted C₁-C₆ mono- or bicyclic aromatic groups. However, all the above amorphous polyamide is not preferable in the present invention. For example, metaxylenediamine adipamide is easily crystallized when heated during a thermal molding process or when oriented, therefore, it is not preferable.

Examples of preferable amorphous polyamides include hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, a copolymer of hexamethylenediamine or 2-methylpentamethylenediamine and an isophthalic acid, terephthalic acid or mixtures thereof. While polyamide based on hexamethylenediamine isophthalamide/terephthalamide, which has a high terephthalic acid content, is useful, it should be mixed with another diamine such as 2-methyldiaminopentane in order to produce an amorphous polyamide that can be processed.

The above amorphous polyamide comprising only the above monomers may contain a small amount of lactam, such as caprolactam or lauryl lactam, as a comonomer. It is important that the polyamide be amorphous. Therefore, any comonomer that does not crystallize polyamide can be used. About 10 wt % or less of a liquid or solid plasticizer, such as glycerole, sorbitol, or toluenesulfoneamide (Santicizer 8 monsanto) can also be included in the amorphous polyamide. For most applications, a glass transition temperature Tg (measured in a dried state, i.e., with a water content of about 0.12 wt % or less) of amorphous polyamide is about 70-170° C., and preferably about 80-160° C. The amorphous polyamide, which is not blended, has a Tg of approximately 125° C. in a dried state. The lower limit of Tg is not clear, but 70° C. is an approximate lower limit. The upper limit of Tg is not clear, too. However, when polyamide with a Tg of about 170° C. or greater is used, thermal molding is difficult. Therefore, polyamide having both an acid and an amine having aromatic groups cannot be thermally molded due to too high Tg, and thus, is not suitable for the purposes of the present invention.

The polyamide may also be a semicrystalline polyamide. The semicrystalline polyamide is generally prepared using lactam, such as nylon 6 or nylon 11, or an amino acid, or is prepared by condensing diamine, such as hexamethylenediamine, with dibasic acid, such as succinic acid, adipic acid, or sebacic acid. The polyamide may be a copolymer or a terpolymer such as a copolymer of hexamethylenediamine/adipic acid and caprolactame (nylon 6, 66). A mixture of two or more crystalline polyamides can also be used. The semicrystalline and amorphous polyamides are prepared by condensation polymerization well-known in the art.

The weight ratio of the resin having barrier properties to the intercalated clay in the nanocomposite is 58.0:42.0 to 99.9:0.1, and preferably 85.0:15.0 to 99.0:1.0. If the weight ratio of the resin having barrier properties to the intercalated clay is less than 58.0:42.0, the intercalated clay agglomerates and dispersing is difficult. If the weight ratio of the resin having barrier properties to the intercalated clay is greater than 99.9:0.1, the improvement in the barrier properties is negligible.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 0.5 to 60 parts by weight, and more preferably 4 to 30 parts by weight. If the content of the nanocomposite is less than 0.5 part by weight, an improvement of a barrier property is negligible. If the content of the nanocomposite is greater than 60 parts by weight, processing is difficult.

The finer the intercalated clay is exfoliated in the resin having barrier property in the nanocomposite, the better the barrier properties that can be obtained. This is because the exfoliated intercalated clay forms a barrier film and thereby improves barrier properties and mechanical properties of the resin itself, and ultimately improves barrier properties and mechanical properties of a molded article prepared from the composition. Accordingly, the ability to form a barrier to gas and liquid is maximized by compounding the resin having barrier properties and the intercalated clay, and dispersing the nano-sized intercalated clay in the resin, thereby maximizing the contact area of the polymer chain and the intercalated clay.

The nanocomposite composition of the present embodiment further includes a compatibilizer/intercalated clay nanocomposite.

The compatibilizer generally has chemical affinity to both the polyolefin resin and the nanocomposite having a barrier property, and thus improves the compatibility of the polyolefin resin in the nanocomposite to form a molded article with a stable structure. However, since the compatibilizer includes a resin with a low molecular weight, it has a poorer barrier property than the polyolefin resin and the nanocomposite. Due to this drawback, an organic solvent or gas can penetrate the compatibilizer. In the present invention, an intercalated clay is added to the compatibilizer to prepare a nanocomposite, thereby improving a barrier property of the compatibilizer.

The compatibilizer may be a hydrocarbon polymer having polar groups. When a hydrocarbon polymer having polar groups is used, the hydrocarbon polymer portion increases the affinity of the compatibilizer to the polyolefin resin and to the nanocomposite having barrier properties, thereby obtaining a molded article with a stable structure.

The compatibilizer can include an compound selected from an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, and a modification thereof.

The intercalated clay used to form the compatibilizer/intercalated clay nanocomposite may be the same as used to prepare the nanocomposite having a barrier property. The compatibilizer/intercalated clay nanocomposite may be formed using the following methods. In one method, monomers are inserted into an organic intercalated clay and the clay platelets are dispersed through inter-layer polymerization. This method is restricted in that it is applicable only when cation polymerization is possible.

The other method is a melt compounding method in which melted polymer chains are inserted into intercalated clay and exfoliated through mechanical compounding.

In the present invention, the compatibilizer and the intercalated clay are compounded to disperse the nano-sized intercalated clay in the compatibilizer, thereby maximizing the contact area of the compatibilizer and the intercalated clay to prevent gas and liquid from penetrating.

The weight ratio of the compatibilizer to the intercalated clay in the compatibilizer/intercalated clay is 85.0:15.0 to 99.0:1.0. When the weight ratio of the compatibilizer to the intercalated clay is less than 85.0:15.0, the intercalated clay agglomerates and dispersing is difficult. When the weight ratio of the compatibilizer to the intercalated clay is greater than 99.0:1.0, the barrier property is not significantly improved.

The content of the compatibilizer/intercalated clay nanocomposite is preferably 1 to 30 parts by weight, and more preferably 3 to 15 parts by weight. When the content of the compatibilizer/intercalated clay nanocomposite is less than 1 part by weight, the mechanical property of a molded article from the composition is poor. When the content of the compatibilizer/intercalated clay nanocomposite is greater than 30 parts by weight, the molding of the composition is difficult.

When an epoxy-modified polystyrene copolymer is used as the compatibilizer, a copolymer comprising a main chain which comprises 70 to 99 parts by weight of styrene and 1 to 30 part by weight of an epoxy compound represented by Formula (1), and branches which comprise 1 to 80 parts by weight of acrylic monomers represented by Formula (2), is preferable.

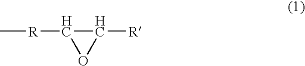

where each of R and R′ is independently a C₁-C₂₀ aliphatic residue or a C₅-C₂₀ aromatic residue having double bonds at its termini

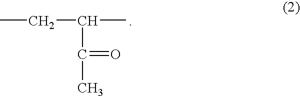

Each of the maleic anhydride modified (graft) high-density polyethylene, maleic anhydride modified (graft) linear low-density polyethylene, and maleic anhydride modified (graft) ethylene-vinyl acetate copolymer preferably comprises branches having 0.1 to 10 parts by weight of maleic anhydride based on 100 parts by weight of the main chain. When the content of the maleic anhydride is less than 0.1 part by weight, it does not function as the compatibilizer. When the content of the maleic anhydride is greater than 10 parts by weight, it is not preferable due to an unpleasant odor.

The nanocomposite composition of the present invention is prepared by dry-blending the nanocomposite having a barrier property in a pellet form, the compatibilizer/intercalated nanocomposite and the polyolefin resin at a constant compositional ratio in a pellet mixer.

Then, the pelletized nanocomposite composition is molded to obtain an article having a barrier property.

The molded article may be obtained by a general molding method including blowing molding, extrusion molding, pressure molding and injection molding.

The article having a barrier property may be a container, a sheet, a film, or pipe.

Hereinafter, the present invention is described in more detail through examples. The following examples are meant only to increase understanding of the present invention, and are not meant to limit the scope of the invention.

### EXAMPLES

The materials used in the following examples are as follows:

EVOH: E105B (Kuraray, Japan)

Nylon 6: EN 500 (KP Chemicals)

HDPE-g-MAH: Compatibilizer, PB3009 (CRAMPTON)

Polyolefin resin: High-density polyethylene (BD 0390, LG CHEM, melt index: 0.3 g/10 min, density: 0.949 g/cm³)

Clay: Closite 30B (SCP)

Thermal stabilizer: IR 1098 (Songwon Inc.)

### Preparation Example 1

(Preparation of EVOH/Intercalated Clay Nanocomposite)

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; φ40). Then, 3 wt % of organic montmorillonite (Southern Intercalated Clay Products, USA; C2OA) as an intercalated clay and 0.1 part by weight of IR 1098 as a thermal stabilizer based on total 100 parts by weight of the EVOH copolymer and the organic montmorillonite were separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 40 kg/hr.

### Preparation Example 2

(Preparation of Nylon 6/Intercalated Clay Nanocomposite)

97 wt % of a polyamide (nylon 6) was put in the main hopper of a twin screw extruder (SM Platek co-rotation twin screw extruder; φ40). Then, 3 wt % of organic montmorillonite as an intercalated clay and 0.1 part by weight of IR 1098 as a thermal stabilizer based on total 100 parts by weight of the polyamide and the organic montmorillonite were separately put in the side feeder of the twin screw extruder to prepare a nylon 6/intercalated clay nanocomposite in a pellet form. The extrusion temperature condition was 220-225-245-245-245-245-245° C., the screws were rotated at 300 rpm, and the discharge condition was 40 kg/hr.

### Preparation Example 3

(Preparation of Ionomer/Intercalated Clay Nanocomposite)

97 wt % of an ionomer was put in the main hopper of a twin screw extruder (SM Platek co-rotation twin screw extruder; φ40). Then, 3 wt % of organic montmorillonite as an intercalated clay and 0.1 part by weight of IR 1098 as a thermal stabilizer based on total 100 parts by weight of the ionomer and the organic montmorillonite were separately put in the side feeder of the twin screw extruder to prepare an ionomer/intercalated clay nanocomposite in a pellet form. The extrusion temperature condition was 220-225-245-245-245-245-245° C., the screws were rotated at 300 rpm, and the discharge condition was 40 kg/hr.

### Preparation Example 4

(Preparation of Compatibilizer/Intercalated Clay Nanocomposite)

97 wt % of a compatibilizer was put in the main hopper of a twin screw extruder (SM Platek co-rotation twin screw extruder; φ40). Then, 3 wt % of organic montmorillonite as an intercalated clay and 0.1 part by weight of IR 1098 as a thermal stabilizer based on total 100 parts by weight of the compatibilizer and the organic montmorillonite were separately put in the side feeder of the twin screw extruder to prepare a compatibilizer/intercalated clay nanocomposite in a pellet form. The extrusion temperature condition was 155-175-175-175-175-175-175° C., the screws were rotated at 300 rpm, and the discharge condition was 40 kg/hr.

### Example 1

25 parts by weight of the EVOH nanocomposite prepared in the Preparation Example 1, 5 parts by weight of the compatibilizer nanocomposite prepared in the Preparation Example 4, and 70 parts by weight of a HDPE were dry-blended and put in a main hopper of a blow-molding machine (SMC-Φ60). Under the extrusion temperature condition of 185-195-195-195° C., a blow-molding process was performed to manufacture a 1000 mL container having a barrier property.

### Example 2

25 parts by weight of the Nylon 6 nanocomposite prepared in the Preparation Example 2, 5 parts by weight of the compatibilizer nanocomposite prepared in the Preparation Example 4, and 70 parts by weight of a HDPE were dry-blended in a double cone mixer (MYDCM-100, MYEONG WOO MICRON SYSTEM) for 30 minutes and put in a main hopper of a blow-molding machine (SMC-Φ60). Under the extrusion temperature condition of 195-210-220-220° C., a blow-molding process was performed to manufacture a 1000 mL container having a barrier property.

### Example 3

25 parts by weight of the Nylon 6 nanocomposite prepared in the Preparation Example 2, 5 parts by weight of the compatibilizer nanocomposite prepared in the Preparation Example 4, and 70 parts by weight of a HDPE were simultaneously put in the main hopper of an blow-molding machine (SMC-Φ60) through belt-type feeders K-TRON Nos. 1, 2 and 3, respectively, and dry-blended. Under the extrusion temperature condition of 195-210-220-220° C., a blow-molding process was performed to manufacture a 1000 mL container having a barrier property.

### Example 4

4 parts by weight of the Nylon 6 nanocomposite prepared in the Preparation Example 2, 2 parts by weight of the compatibilizer nanocomposite prepared in the Preparation Example 4, and 94 parts by weight of a HDPE were dry-blended in a double cone mixer (MYDCM-100, MYEONG WOO MICRON SYSTEM) for 30 minutes and put in a main hopper of a blow-molding machine (SMC-Φ60). Under the extrusion temperature condition of 195-210-220-220° C., a blow-molding process was performed to manufacture a 1000 mL container having a barrier property.

### Example 5

40 parts by weight of the Nylon 6 nanocomposite prepared in the Preparation Example 2, 20 parts by weight of the compatibilizer nanocomposite prepared in the Preparation Example 4, and 40 parts by weight of a HDPE were dry-blended in a double cone mixer (MYDCM-100, MYEONG WOO MICRON SYSTEM) for 30 minutes and put in a main hopper of a blow-molding machine (SMC-Φ60). Under the extrusion temperature condition of 195-210-220-220° C., a blow-molding process was performed to manufacture a 1000 mL container having a barrier property.

### Example 6

25 parts by weight of the ionomer nanocomposite prepared in the Preparation Example 3, 5 parts by weight of the compatibilizer nanocomposite prepared in the Preparation Example 4, and 70 parts by weight of a HDPE were dry-blended in a double cone mixer (MYDCM-100, MYEONG WOO MICRON SYSTEM) for 30 minutes and put in a main hopper of a blow-molding machine (SMC-Φ60). Under the extrusion temperature condition of 240-265-265-265° C., a blow-molding process was performed to manufacture a 1000 mL container having a barrier property.

### Comparative Example 1

A container having a barrier property was manufactured in the same manner as in Example 1, except that organic montmorillonite as an intercalated clay was not used.

### Comparative Example 2

A container having a barrier property was manufactured in the same manner as in Example 2, except that an organic montmorillonite as an intercalated clay was not used.

### Comparative Example 3

A container having a barrier property was manufactured in the same manner as in Example 3, except that an organic montmorillonite as an intercalated clay was not used.

### Experimental Example

a) Liquid Barrier Property

Toluene, Desys herbicide (1% of deltametrine+emulsifier, stabilizer, and solvent; Kyung Nong), Batsa insecticide (50% of BPMC+50% of emulsifier and solvent), and water were put in the containers manufactured in Examples 1 to 6 and Comparative Examples 1 to 3. Then, the weight change was determined after 30 days under a condition of forced exhaust at 50° C. For toluene, the weight change was further determined at room temperature (23° C.).

b) Gas Barrier Properties (cc/m²·day·atm)

The containers manufactured in Examples 1 to 6 and Comparative Examples 1 to 3 were left alone under a temperature of 23° C. and a relative humidity of 50% for 1 day. Then, the gas penetration rate was determined (Mocon OX-TRAN 2/20, U.S.A).

TABLE 1
Gas Barrier Property

| | Oxygen penetration | Moisture penetration |
|---|---|---|
| | (cm²/m² · 24 hrs · atm) | (g/m² · 24 hrs) |
| Example 1 | 7.4 | 1.14 |
| Example 2 | 3.2 | 1.01 |
| Example 3 | 3.4 | 1.03 |
| Example 4 | 13.9 | 0.99 |
| Example 5 | 1.84 | 1.19 |
| Example 6 | 14.1 | 1.12 |
| Comparative Example 1 | 79.4 | 1.59 |
| Comparative Example 2 | 86.8 | 1.52 |
| Comparative Example 3 | 98.1 | 2.11 |

TABLE 2
Liquid Barrier Property

| | Liquid barrier properties (%) | | | | |
|---|---|---|---|---|---|
| | Weight | | | | |
| | change at | | | | |
| | 25° C. | Weight change at 50° C. | | | |
| Classification | Toluene | Toluene | Desys | Batsa | Water |
| Example 1 | 0.033 | 0.413 | 0.135 | 0.029 | 0.0013 |
| Example 2 | 0.011 | 0.108 | 0.081 | 0.012 | 0.0015 |
| Example 3 | 0.015 | 0.129 | 0.088 | 0.015 | 0.0014 |
| Example 4 | 0.032 | 0.275 | 0.149 | 0.020 | 0.0011 |
| Example 5 | 0.007 | 0.040 | 0.031 | 0.029 | 0.0019 |
| Example 6 | 0.042 | 0.632 | 0.104 | 0.094 | 0.0017 |
| Comparative | 0.430 | 5.993 | 1.274 | 0.474 | 0.0020 |
| Example 1 | | | | | |
| Comparative | 0.623 | 6.319 | 1.532 | 0.651 | 0.0031 |
| Example 2 | | | | | |
| Comparative | 1.125 | 8.304 | 1.849 | 0.847 | 0.0033 |
| Example 3 | | | | | |

As shown in Tables 1 and 2, containers of Examples 1 to 6 have superior gas and liquid barrier properties compared to those of Comparative Examples 1 to 3.

The article manufactured from the nanocomposite composition according to an embodiment of the present invention has superior mechanical strength and moldability, and superior oxygen, organic solvent, and moisture barrier properties.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A dry-blended nanocomposite composition comprising:
40 to 96 parts by weight of a polyolefin resin;
1 to 30 parts by weight of a compatibilizer/intercalated clay nanocomposite; and
0.5 to 60 parts by weight of a nanocomposite having a barrier property, including an intercalated clay and at least one resin having a barrier property, selected from the group consisting of an ethylene-vinyl alcohol copolymer, a polyamide, an ionomer and a polyvinyl alcohol.

2. The composition of claim 1, wherein the weight ratio of the resin having a barrier property to the intercalated clay in the nanocomposite is 58.0:42.0 to 99.9:0.1.

3. The composition of claim 1, wherein the intercalated clay is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

4. The composition of claim 1, wherein the intercalated clay comprises 1 to 45 wt % of an organic material.

5. The composition of claim 4, wherein the organic material has at least one functional group selected from the group consisting of from primary ammonium to quaternary ammonium, phosphonium, maleate, succinate, acrylate, benzylic hydrogen, oxazoline, and dimethyldistearylammonium.

6. The composition of claim 1, wherein the ethylene-vinyl alcohol copolymer contains 10 to 50 mol % of ethylene.

7. The composition of claim 1, wherein the polyamide is nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

8. The composition of claim 7, wherein the glass transition temperature of the amorphous polyamide is about 80-130° C.

9. The composition of claim 7, wherein the amorphous polyamide is selected from the group consisting of hexamethylenediamine isophthalamide, hexamethylene diamine isophthalamide/terephthalamide terpolymer having a ratio of isophthalic acid/terephthalic acid of 99/1 to 60/40, a mixture of 2,2,4- and 2,4,4-trimethylhexamethylenediamine terephthalamide, and a copolymer of hexamethylenediamine or 2-methylpentamethylenediamine and isophthalic acid, terephthalic acid, or a mixture thereof.

10. The composition of claim 9, wherein the amorphous polyamide is hexamethylene diamine isophthalamide/terephthalamide terpolymer having a ratio of isophthalic acid to terephthalic acid of 70:30.

11. The composition of claim 1, wherein the ionomer has a melt index of 0.1 to 10 g/10 min (190° C., 2,160 g).

12. The composition of claim 1, wherein the compatibilizer is one or more compounds selected from the group consisting of an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, and a maleic anhydride modified (graft) ethylene-vinyl acetate copolymer.

13. The composition of claim 1, wherein the weight ratio of the compatibilizer to the intercalated clay in the compatibilizer/intercalated clay nanocomposite is 85:15 to 99:1.

14. An article manufactured from the nanocomposite composition of claim 1.

15. The article of claim 14, being a container, a film, a pipe, or a sheet.

16. The article of claim 14, manufactured through blow molding, extrusion molding, pressure molding, or injection molding.
